(19) United States
(12) Patent Application Publication
(10) Pub. No.: US 2026/0126956 A1
(43) Pub. Date: May 7, 2026

(54) PSEUDORANDOM NUMBER GENERATOR CIRCUIT

(71) Applicant: Microsoft Technology Licensing, LLC, Redmond, WA (US)

(72) Inventor: Thomas Craig SAVELL, Emeryville, CA (US)

(73) Assignee: Microsoft Technology Licensing, LLC, Redmond, WA (US)

(21) Appl. No.: 18/938,189

(22) Filed: Nov. 5, 2024

(51) Int. Cl. G06F 7/58; G06F 7/499

(52) U.S. Cl. CPC G06F 7/584; G06F 7/49947

(57) ABSTRACT

A computing system including hardware accelerator that includes a pseudorandom number generator (PRNG) circuit. The PRNG circuit is configured to compute an initial pseudorandom bit stream. The PRNG circuit is further configured to compute a plurality of output pseudorandom bit streams as sequences of bits selected from respective initial stream bit indices within the initial pseudorandom bit stream. For each of the output pseudorandom bit streams, for each output stream bit index within that output pseudorandom bit stream, the corresponding initial stream bit index is unique, across the plurality of output pseudorandom bit streams, among values of the initial stream bit index from which the PRNG circuit obtains the bit located at that output stream bit index. The PRNG circuit is further configured to output the plurality of output pseudorandom bit streams.

### BACKGROUND

Generating truly random inputs to a computing process typically requires an analog noise source. Hardware devices used as analog noise sources may be prohibitively expensive for computing applications that use large numbers of random inputs. In addition, many applications utilize deterministic and repeatable random number sequences, e.g., for debugging failures, and analog sources are non-deterministic and non-repeatable. Accordingly, pseudorandom number generators are frequently used instead of true random number generators.

A pseudorandom number generator is a process or device that deterministically computes outputs mimicking random outputs. The outputs of a pseudorandom number generator may be indistinguishable, up to some guarantee, from random outputs sampled from a specified probability distribution. The guarantee may, for example, be a number of outputs needed to predict a subsequent value of an output sequence or distinguish the pseudorandom sequence from a random sequence. The pseudorandom number generator may accordingly produce outputs that are usable in place of truly random outputs in many computing processes.

### SUMMARY

According to one aspect of the present disclosure, a computing system is provided, including hardware accelerator that includes a pseudorandom number generator (PRNG) circuit. The PRNG circuit is configured to compute an initial pseudorandom bit stream. The PRNG circuit is further configured to compute a plurality of output pseudorandom bit streams as sequences of bits selected from respective initial stream bit indices within the initial pseudorandom bit stream. For each of the output pseudorandom bit streams, for each output stream bit index within that output pseudorandom bit stream, the corresponding initial stream bit index is unique, across the plurality of output pseudorandom bit streams, among values of the initial stream bit index from which the PRNG circuit obtains the bit located at that output stream bit index. The PRNG circuit is further configured to output the plurality of output pseudorandom bit streams.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 schematically shows a computing system including a hardware accelerator that includes a pseudorandom number generator (PRNG) circuit, according to one example embodiment.

FIG. 2A schematically shows the PRNG circuit in additional detail in an example in which an initial pseudorandom bit stream is computed using a synchronous stream cipher such as a Trivium algorithm and used to generate a plurality of output pseudorandom bit streams, according to the example of FIG. 1.

FIG. 2B schematically shows the PRNG circuit in additional detail in an example in which the initial pseudorandom bit stream is computed using one or more linear feedback shift registers, according to the example of FIG. 1.

FIG. 2C schematically shows the PRNG circuit in additional detail in an example in which, among a plurality of output pseudorandom bit streams, repeats of initial stream bit indices are allowed at some output stream bit indices, according to the example of FIG. 1.

FIG. 3 schematically shows a stochastic rounding circuit configured to receive the output pseudorandom bit streams and perform stochastic rounding, according to the example of FIG. 1.

FIG. 4 schematically shows the PRNG circuit and a controller included in the hardware accelerator as the hardware accelerator progresses through a plurality of clock cycles, according to the example of FIG. 1.

FIG. 5 schematically shows the computing system 1 when the PRNG circuit replays the computation of the output pseudorandom bit streams, according to the example of FIG. 1.

FIG. 6 schematically shows the computing system in an example in which one or more processing devices are configured to execute a stochastic search algorithm using the output pseudorandom bit streams, according to the example of FIG. 1.

FIG. 7 schematically shows the computing system in an example in which one or more processing devices are configured to perform dithering using the output pseudorandom bit streams, according to the example of FIG. 1.

FIG. 8A shows a flowchart of a method for use with a computing system including a hardware accelerator that includes a PRNG circuit, according to the example of FIG. 1.

FIG. 8B shows additional steps of the method of FIG. 8A that may be performed in examples in which the output pseudorandom bit streams are used in stochastic rounding.

FIG. 8C shows additional steps of the method of FIG. 8A that may be performed at the PRNG circuit in some examples.

FIG. 8D shows additional steps of the method of FIG. 8A that may be performed at the PRNG circuit in some examples to replay output pseudorandom bit stream computation.

FIG. 8E shows steps of the method of FIG. 8A that may be performed at one or more additional processing devices in some examples when the output pseudorandom bit streams are used as inputs to computations other than stochastic rounding.

FIG. 9 shows a schematic view of an example computing environment in which the computing system of FIG. 1 may be instantiated.

### DETAILED DESCRIPTION

Pseudorandom number generators are used in a wide variety of computing applications. As one example, pseudorandom number generators can be used to generate random numbers used in stochastic rounding applications related to machine learning model quantization. As another example, pseudorandom number generators can be used to generate numbers used in stochastic rounding applications related to dithering. Numerous other applications exist as well. The techniques described herein offer particular benefit when a very large number of pseudorandom numbers is generated, which is often the case in machine learning model quantization since a modern machine learning model can be quite large.

Machine learning model quantization has recently seen increasing use to reduce the training and inferencing costs of machine learning models. When quantization is performed, the parameters of a machine learning model are compressed into a data format that has a lower precision. For example, parameters stored in a 16-bit floating-point (FP16) format may be compressed into a four-bit floating-point (FP4) format. Quantization may be used to accelerate the processing of machine learning model inputs at the cost of a reduction in accuracy.

When machine learning model parameters are quantized, rounding is performed on those parameters. Stochastic rounding is a rounding approach that may be used when computing quantized parameter values. In stochastic rounding, a value is rounded toward positive infinity or toward negative infinity, with the direction of rounding being stochastically determined. The selection probabilities of the rounding directions depend on the size of the fractional part. For example, stochastic rounding to the nearest integer may be performed using the following formula:

$$Round ( x ) = \{ \begin{matrix}⌊ x ⌋ with probability ⌊ x ⌋ - x + 1 \\ ⌊ x ⌋ + 1 with probability x - ⌊ x ⌋\end{matrix}$$

In some examples, stochastic rounding may be performed on a number multiple times. The approximate value of the original number may, in such examples, be reconstructed by computing the mean of the rounded values.

Large language models (LLMs) and large multimodal models (LMMs) can include billions to trillions of parameters. Accordingly, when quantizing the parameters of an LLM or LMM using stochastic rounding, large numbers of rounding direction determinations are performed, especially in examples in which stochastic rounding is performed multiple times to allow the original values of the parameters to be reconstructed. Such large numbers of rounding directions would be impractical to stochastically select using an analog noise source. Thus, a pseudorandom number generator is used instead.

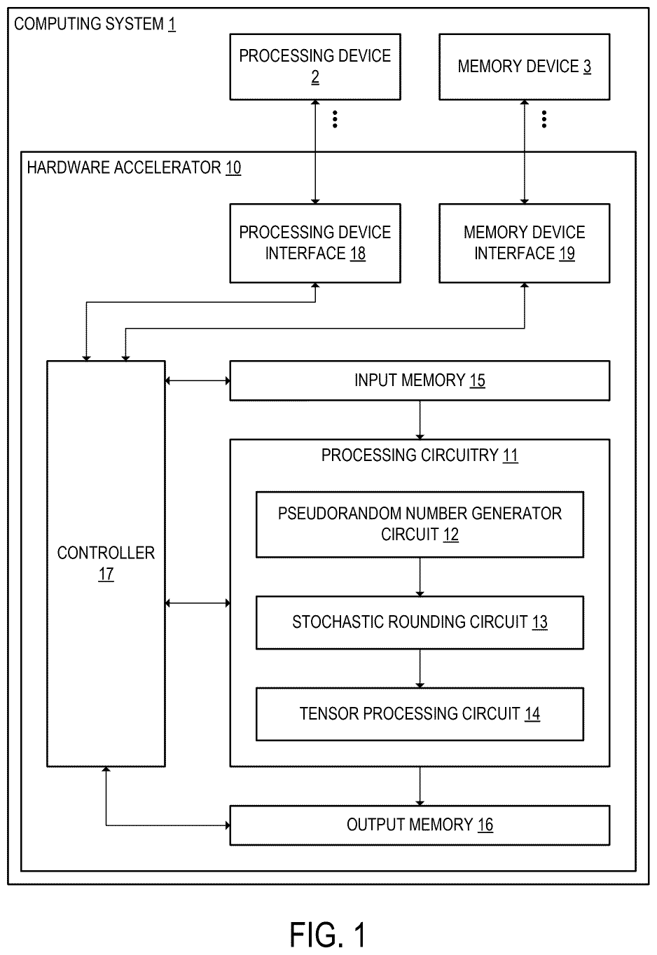

FIG. 1 schematically shows a computing system 1 including a hardware accelerator 10. The hardware accelerator 10 includes processing circuitry 11 that includes a pseudorandom number generator (PRNG) circuit 12. At the PRNG circuit 12, the hardware accelerator 10 is configured to efficiently generate pseudorandom bit streams, as discussed in further detail below. In addition, the processing circuitry 11 of the hardware accelerator 10 shown in FIG. 1 further includes a stochastic rounding circuit 13. The stochastic rounding circuit 13 is configured to perform stochastic rounding using the pseudorandom bit streams generated at the pseudorandom number generator circuit 12. Accordingly, the processing circuitry 11 of the hardware accelerator 10 may be configured to efficiently quantize parameters of a neural network.

Other components of the hardware accelerator 10 are further shown in FIG. 1. In the example of FIG. 1, the processing circuitry 11 further includes a tensor processing circuit 14 that is configured to perform predefined computations on tensor-valued inputs. For example, the tensor processing circuit 14 may be configured to perform addition and/or multiplication operations that take vectors or matrices as inputs. Large numbers of these tensor operations are performed during machine learning model inferencing. By quantizing neural network parameters using the PRNG circuit 12 and the stochastic rounding circuit 13, the efficiency of the tensor operations may be increased in terms of time, chip area, and energy consumption.

FIG. 1 further shows input memory 15 and output memory 16 of the processing circuitry 11 that are included in the hardware accelerator 10. In addition, FIG. 1 shows a controller 17 that is configured to transmit control instructions to the processing circuitry 11.

The computing system 1 shown in FIG. 1 further includes one or more additional processing devices 2 and memory devices 3. The one or more processing devices 2 may, for example, include one or more central processing units (CPUs) and/or other hardware accelerators. The one or more memory devices 3 may include volatile memory and/or non-volatile storage. The one or more processing devices 2 may be configured to communicate with the controller 17 of the hardware accelerator 10 over a processing device interface 18. The one or more memory devices 3 may be configured to communicate with the controller 17 over a memory device interface 19. Thus, the hardware accelerator 10 is configured to transmit data to, and receive data from, other components of the computing system 1.

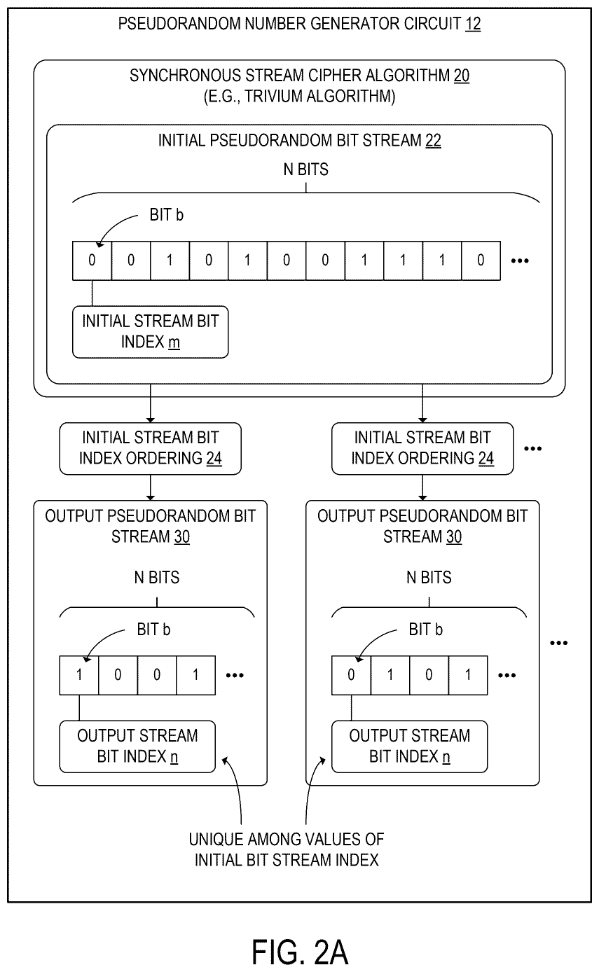

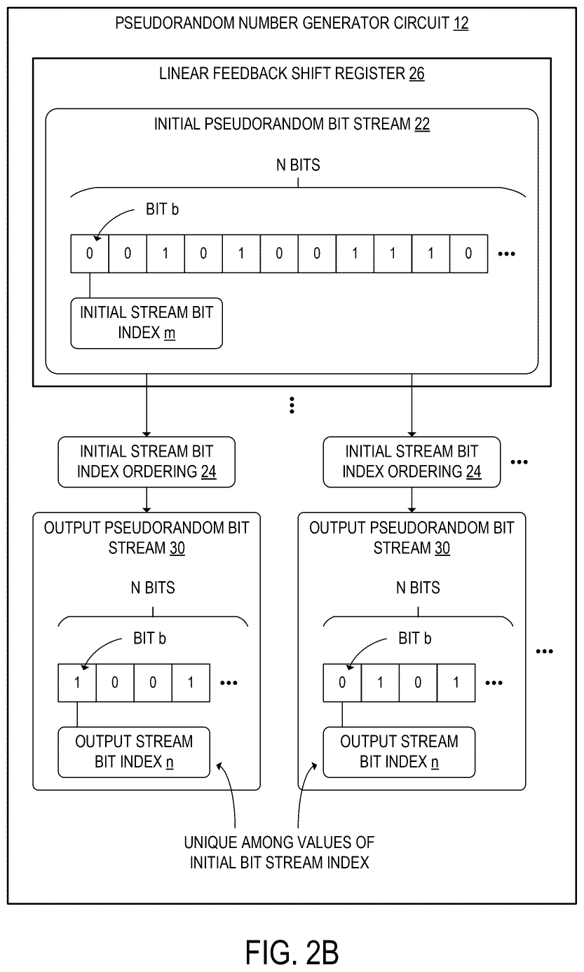

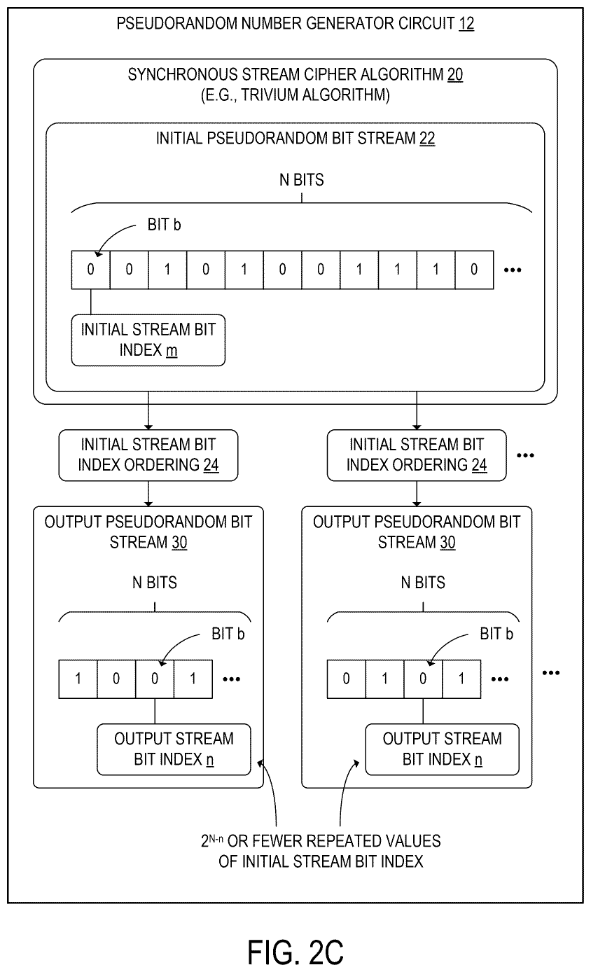

FIG. 2A schematically shows the PRNG circuit 12 in additional detail, according to one example. The PRNG circuit 12 is configured to compute an initial pseudorandom bit stream 22 that includes a plurality of bits b. The bits b of the initial pseudorandom bit stream 22 have respective initial stream bit indices m that indicate the positions of those bits b within the initial pseudorandom bit stream 22. The input pseudorandom bit stream 22 includes a total of N bits.

In the example of FIG. 2A, the PRNG circuit 12 is configured to compute the initial pseudorandom bit stream 22 by executing a synchronous stream cipher algorithm 20, such as a Trivium algorithm 20. The Trivium algorithm is disclosed in “Trivium: A Stream Cipher Construction Inspired by Block Cipher Design Principles” (Cannière and Preneel, 2008), which is hereby incorporated herein by reference. (See also, ISO/IEC 29192-3, October 2010.) The Trivium cipher is designed to be K-secure from distinguishing attacks, which are attacks that attempt to distinguish between the outputs of the cipher and a truly random sequence. K-security means that the cipher is equivalently secure to a set of 2^{k} functions S_{K}:{0,1}ⁿ×{0, . . . , 2^{d}−1}→{0,1} uniformly selected from the set of all possible functions, where k is the number of bits in a secret key and where the cipher generates a 2ª-bit key stream. Since Trivium is K-secure from distinguishing attacks, Trivium may also be used as a pseudorandom bit stream generation protocol. The Trivium algorithm 20 used in FIG. 2A may, for example, be a Trivium64 algorithm configured to generate a 64-bit initial pseudorandom bit stream 22.

The PRNG circuit 12 is further configured to compute a plurality of output pseudorandom bit streams 30. The output pseudorandom bit streams 30 are sequences of bits b selected from respective initial stream bit indices m within the initial pseudorandom bit stream 22. In the example of FIG. 2A, the PRNG circuit 12 is configured to compute the plurality of output pseudorandom bit streams 30 in parallel. The output pseudorandom bit streams 30 each have a respective initial stream bit index ordering 24 of the initial bit stream indices m from which the bits b of the output pseudorandom bit stream 30 are selected. Each of the output pseudorandom bit streams 30 includes a total of N bits. The bits of the output pseudorandom bit streams 30 each have respective output stream bit indices n that indicate the positions of those bits b within the output pseudorandom bit stream 30. Accordingly, each initial stream bit index ordering 24 maps the sequence of initial bit stream indices m to a sequence of output stream bit indices n.

The initial stream bit index orderings 24 may be represented as rows of an array. In the example of FIG. 2A, when the initial stream bit index orderings 24 are represented as rows of an array, that array forms a Latin rectangle. In a Latin rectangle, no entry occurs more than once in any row or column. Accordingly, for each of the output pseudorandom bit streams 30, for each output stream bit index n within that output pseudorandom bit stream 30, a uniqueness property holds. That uniqueness property specifies that across the plurality of output pseudorandom bit streams 30, the corresponding initial stream bit index m from which the PRNG circuit 12 obtains the bit b located at that output stream bit index n is unique among values of the initial stream bit index m. In the set of output pseudorandom bit streams 30 computed from the initial pseudorandom bit stream 22, the PRNG circuit 12 does not repeat any values of m for a given value of n.

The following table shows example initial stream bit index orderings 24 of a plurality of output pseudorandom bit streams 30. In this example, the Trivium algorithm is Trivium64. The PRNG circuit 12 is configured to generate 64 output pseudorandom bit streams 30, each of which includes 22 bits.

| Str. | Bit | | | | | | | | | | | | | | | | | | | | | |
|---|---|---|---|---|---|---|---|---|---|---|---|---|---|---|---|---|---|---|---|---|---|---|
| ID | 21 | 20 | 19 | 18 | 17 | 16 | 15 | 14 | 13 | 12 | 11 | 10 | 9 | 8 | 7 | 6 | 5 | 4 | 3 | 2 | 1 | 0 |
| 1 | 0 | 63 | 32 | 31 | 48 | 15 | 56 | 7 | 60 | 3 | 2 | 61 | 14 | 49 | 28 | 35 | 46 | 17 | 6 | 57 | 38 | 25 |
| 2 | 1 | 62 | 33 | 30 | 49 | 14 | 57 | 6 | 61 | 2 | 3 | 60 | 15 | 48 | 29 | 34 | 47 | 16 | 7 | 56 | 39 | 24 |
| 3 | 2 | 61 | 34 | 29 | 50 | 13 | 58 | 5 | 62 | 1 | 4 | 59 | 16 | 47 | 30 | 33 | 48 | 15 | 8 | 55 | 40 | 23 |
| 4 | 3 | 60 | 35 | 28 | 51 | 12 | 59 | 4 | 63 | 0 | 5 | 58 | 17 | 46 | 31 | 32 | 49 | 14 | 9 | 54 | 41 | 22 |
| 5 | 4 | 59 | 36 | 27 | 52 | 11 | 60 | 3 | 0 | 63 | 6 | 57 | 18 | 45 | 32 | 31 | 50 | 13 | 10 | 53 | 42 | 21 |
| 6 | 5 | 58 | 37 | 26 | 53 | 10 | 61 | 2 | 1 | 62 | 7 | 56 | 19 | 44 | 33 | 30 | 51 | 12 | 11 | 52 | 43 | 20 |
| 7 | 6 | 57 | 38 | 25 | 54 | 9 | 62 | 1 | 2 | 61 | 8 | 55 | 20 | 43 | 34 | 29 | 52 | 11 | 12 | 51 | 44 | 19 |
| 8 | 7 | 56 | 39 | 24 | 55 | 8 | 63 | 0 | 3 | 60 | 9 | 54 | 21 | 42 | 35 | 28 | 53 | 10 | 13 | 50 | 45 | 18 |
| 9 | 8 | 55 | 40 | 23 | 56 | 7 | 0 | 63 | 4 | 59 | 10 | 53 | 22 | 41 | 36 | 27 | 54 | 9 | 14 | 49 | 46 | 17 |
| 10 | 9 | 54 | 41 | 22 | 57 | 6 | 1 | 62 | 5 | 58 | 11 | 52 | 23 | 40 | 37 | 26 | 55 | 8 | 15 | 48 | 47 | 16 |
| 11 | 10 | 53 | 42 | 21 | 58 | 5 | 2 | 61 | 6 | 57 | 12 | 51 | 24 | 39 | 38 | 25 | 56 | 7 | 16 | 47 | 48 | 15 |
| 12 | 11 | 52 | 43 | 20 | 59 | 4 | 3 | 60 | 7 | 56 | 13 | 50 | 25 | 38 | 39 | 24 | 57 | 6 | 17 | 46 | 49 | 14 |
| 13 | 12 | 51 | 44 | 19 | 60 | 3 | 4 | 59 | 8 | 55 | 14 | 49 | 26 | 37 | 40 | 23 | 58 | 5 | 18 | 45 | 50 | 13 |
| 14 | 13 | 50 | 45 | 18 | 61 | 2 | 5 | 58 | 9 | 54 | 15 | 48 | 27 | 36 | 41 | 22 | 59 | 4 | 19 | 44 | 51 | 12 |
| 15 | 14 | 49 | 46 | 17 | 62 | 1 | 6 | 57 | 10 | 53 | 16 | 47 | 28 | 35 | 42 | 21 | 60 | 3 | 20 | 43 | 52 | 11 |
| 16 | 15 | 48 | 47 | 16 | 63 | 0 | 7 | 56 | 11 | 52 | 17 | 46 | 29 | 34 | 43 | 20 | 61 | 2 | 21 | 42 | 53 | 10 |
| 17 | 16 | 47 | 48 | 15 | 0 | 63 | 8 | 55 | 12 | 51 | 18 | 45 | 30 | 33 | 44 | 19 | 62 | 1 | 22 | 41 | 54 | 9 |
| 18 | 17 | 46 | 49 | 14 | 1 | 62 | 9 | 54 | 13 | 50 | 19 | 44 | 31 | 32 | 45 | 18 | 63 | 0 | 23 | 40 | 55 | 8 |
| 19 | 18 | 45 | 50 | 13 | 2 | 61 | 10 | 53 | 14 | 49 | 20 | 43 | 32 | 31 | 46 | 17 | 0 | 63 | 24 | 39 | 56 | 7 |
| 20 | 19 | 44 | 51 | 12 | 3 | 60 | 11 | 52 | 15 | 48 | 21 | 42 | 33 | 30 | 47 | 16 | 1 | 62 | 25 | 38 | 57 | 6 |
| 21 | 20 | 43 | 52 | 11 | 4 | 59 | 12 | 51 | 16 | 47 | 22 | 41 | 34 | 29 | 48 | 15 | 2 | 61 | 26 | 37 | 58 | 5 |
| 22 | 21 | 42 | 53 | 10 | 5 | 58 | 13 | 50 | 17 | 46 | 23 | 40 | 35 | 28 | 49 | 14 | 3 | 60 | 27 | 36 | 59 | 4 |
| 23 | 22 | 41 | 54 | 9 | 6 | 57 | 14 | 49 | 18 | 45 | 24 | 39 | 36 | 27 | 50 | 13 | 4 | 59 | 28 | 35 | 60 | 3 |
| 24 | 23 | 40 | 55 | 8 | 7 | 56 | 15 | 48 | 19 | 44 | 25 | 38 | 37 | 26 | 51 | 12 | 5 | 58 | 29 | 34 | 61 | 2 |
| 25 | 24 | 39 | 56 | 7 | 8 | 55 | 16 | 47 | 20 | 43 | 26 | 37 | 38 | 25 | 52 | 11 | 6 | 57 | 30 | 33 | 62 | 1 |
| 26 | 25 | 38 | 57 | 0 | 9 | 54 | 17 | 46 | 21 | 42 | 27 | 36 | 39 | 24 | 53 | 10 | 7 | 56 | 31 | 32 | 63 | 0 |
| 27 | 26 | 37 | 58 | 5 | 10 | 53 | 18 | 45 | 22 | 41 | 28 | 35 | 40 | 23 | 54 | 9 | 8 | 55 | 32 | 31 | 0 | 63 |
| 28 | 27 | 36 | 59 | 4 | 11 | 52 | 19 | 44 | 23 | 40 | 29 | 34 | 41 | 22 | 55 | 8 | 9 | 54 | 33 | 30 | 1 | 62 |
| 29 | 28 | 35 | 60 | 3 | 12 | 51 | 20 | 43 | 24 | 39 | 30 | 33 | 42 | 21 | 56 | 7 | 10 | 53 | 34 | 29 | 2 | 61 |
| 30 | 29 | 34 | 61 | 2 | 13 | 50 | 21 | 42 | 25 | 38 | 31 | 32 | 43 | 20 | 57 | 6 | 11 | 52 | 35 | 28 | 3 | 60 |
| 31 | 30 | 33 | 62 | 1 | 14 | 49 | 22 | 41 | 26 | 37 | 32 | 31 | 44 | 19 | 58 | 5 | 12 | 51 | 36 | 27 | 4 | 59 |
| 32 | 31 | 32 | 63 | 0 | 15 | 48 | 23 | 40 | 27 | 36 | 33 | 30 | 45 | 18 | 59 | 4 | 13 | 50 | 37 | 26 | 5 | 58 |
| 33 | 32 | 31 | 0 | 63 | 16 | 47 | 24 | 39 | 28 | 35 | 34 | 29 | 46 | 17 | 60 | 3 | 14 | 49 | 38 | 25 | 6 | 57 |
| 34 | 33 | 30 | 1 | 62 | 17 | 46 | 25 | 38 | 29 | 34 | 35 | 28 | 47 | 16 | 61 | 2 | 15 | 48 | 39 | 24 | 7 | 56 |
| 35 | 34 | 29 | 2 | 61 | 18 | 45 | 26 | 37 | 30 | 33 | 36 | 27 | 48 | 15 | 62 | 1 | 16 | 47 | 40 | 23 | 8 | 55 |
| 36 | 35 | 28 | 3 | 60 | 19 | 44 | 27 | 36 | 31 | 32 | 37 | 26 | 49 | 14 | 63 | 0 | 17 | 46 | 41 | 22 | 9 | 54 |
| 37 | 36 | 27 | 1 | 59 | 20 | 43 | 28 | 35 | 32 | 31 | 38 | 25 | 50 | 13 | 0 | 63 | 18 | 45 | 42 | 21 | 10 | 53 |
| 38 | 37 | 26 | 5 | 58 | 21 | 42 | 29 | 34 | 33 | 30 | 39 | 24 | 51 | 12 | 1 | 62 | 19 | 44 | 43 | 20 | 11 | 52 |
| 39 | 38 | 25 | 6 | 57 | 22 | 41 | 30 | 33 | 34 | 29 | 40 | 23 | 52 | 11 | 2 | 61 | 20 | 43 | 44 | 19 | 12 | 51 |
| 40 | 39 | 24 | 7 | 56 | 23 | 40 | 31 | 32 | 35 | 28 | 41 | 22 | 53 | 10 | 3 | 60 | 21 | 42 | 45 | 18 | 13 | 50 |
| 41 | 40 | 23 | 8 | 55 | 24 | 39 | 32 | 31 | 36 | 27 | 42 | 21 | 54 | 9 | 4 | 59 | 22 | 41 | 46 | 17 | 14 | 49 |
| 42 | 41 | 22 | 9 | 54 | 25 | 38 | 33 | 30 | 37 | 26 | 43 | 20 | 55 | 8 | 5 | 58 | 23 | 40 | 47 | 16 | 15 | 48 |
| 43 | 42 | 21 | 10 | 53 | 26 | 37 | 34 | 29 | 38 | 25 | 44 | 19 | 56 | 7 | 6 | 57 | 24 | 39 | 48 | 15 | 16 | 47 |
| 44 | 43 | 20 | 11 | 52 | 27 | 36 | 35 | 28 | 39 | 24 | 45 | 18 | 57 | 6 | 7 | 56 | 25 | 38 | 49 | 14 | 17 | 46 |
| 45 | 44 | 19 | 12 | 51 | 28 | 35 | 36 | 27 | 40 | 23 | 46 | 17 | 58 | 5 | 8 | 55 | 26 | 37 | 50 | 13 | 18 | 45 |
| 46 | 45 | 18 | 13 | 50 | 29 | 34 | 37 | 26 | 41 | 22 | 47 | 16 | 59 | 4 | 9 | 54 | 27 | 36 | 51 | 12 | 19 | 44 |
| 47 | 46 | 17 | 14 | 49 | 30 | 33 | 38 | 25 | 42 | 21 | 48 | 15 | 60 | 3 | 10 | 53 | 28 | 35 | 52 | 11 | 20 | 43 |
| 48 | 47 | 16 | 15 | 48 | 31 | 32 | 39 | 24 | 43 | 20 | 49 | 14 | 61 | 2 | 11 | 52 | 29 | 34 | 53 | 10 | 21 | 42 |
| 49 | 48 | 15 | 16 | 47 | 32 | 31 | 40 | 23 | 11 | 19 | 50 | 13 | 62 | 1 | 12 | 51 | 30 | 33 | 54 | 9 | 22 | 41 |
| 50 | 49 | 14 | 17 | 46 | 33 | 30 | 41 | 22 | 45 | 18 | 51 | 12 | 63 | 0 | 13 | 50 | 31 | 32 | 55 | 8 | 23 | 40 |
| 51 | 50 | 13 | 18 | 45 | 34 | 29 | 42 | 21 | 46 | 17 | 52 | 11 | 0 | 63 | 14 | 49 | 32 | 31 | 56 | 7 | 24 | 39 |
| 52 | 51 | 12 | 19 | 44 | 35 | 28 | 43 | 20 | 47 | 16 | 53 | 10 | 1 | 62 | 15 | 48 | 33 | 30 | 57 | 6 | 25 | 38 |
| 53 | 52 | 11 | 20 | 43 | 36 | 27 | 44 | 19 | 48 | 15 | 54 | 9 | 2 | 61 | 16 | 47 | 34 | 29 | 58 | 5 | 26 | 37 |
| 54 | 53 | 10 | 21 | 42 | 37 | 26 | 45 | 18 | 49 | 14 | 55 | 8 | 3 | 60 | 17 | 46 | 35 | 28 | 59 | 4 | 27 | 36 |
| 55 | 54 | 9 | 22 | 41 | 38 | 25 | 46 | 17 | 50 | 13 | 56 | 7 | 4 | 59 | 18 | 45 | 36 | 27 | 60 | 3 | 28 | 35 |
| 56 | 55 | 8 | 23 | 40 | 39 | 24 | 47 | 16 | 51 | 12 | 57 | 6 | 5 | 58 | 19 | 44 | 37 | 26 | 61 | 2 | 29 | 34 |
| 57 | 56 | 7 | 24 | 39 | 40 | 23 | 48 | 15 | 52 | 11 | 58 | 5 | 6 | 57 | 20 | 43 | 38 | 25 | 62 | 1 | 30 | 33 |
| 58 | 57 | 6 | 25 | 38 | 41 | 22 | 49 | 14 | 53 | 10 | 59 | 4 | 7 | 56 | 21 | 42 | 39 | 24 | 63 | 0 | 31 | 32 |
| 59 | 58 | 5 | 26 | 37 | 42 | 21 | 50 | 13 | 54 | 9 | 60 | 3 | 8 | 55 | 22 | 41 | 40 | 23 | 0 | 63 | 32 | 31 |
| 60 | 59 | 4 | 27 | 36 | 43 | 20 | 51 | 12 | 55 | 8 | 61 | 2 | 9 | 54 | 23 | 40 | 41 | 22 | 1 | 62 | 33 | 30 |
| 61 | 60 | 3 | 28 | 35 | 44 | 19 | 52 | 11 | 56 | 7 | 62 | 1 | 10 | 53 | 24 | 39 | 42 | 21 | 2 | 61 | 34 | 29 |
| 62 | 61 | 2 | 29 | 34 | 45 | 18 | 53 | 10 | 57 | 6 | 63 | 0 | 11 | 52 | 25 | 38 | 43 | 20 | 3 | 60 | 35 | 28 |
| 63 | 62 | 1 | 30 | 33 | 46 | 17 | 54 | 9 | 58 | 5 | 0 | 63 | 12 | 51 | 26 | 37 | 44 | 19 | 4 | 59 | 36 | 27 |
| 64 | 63 | 0 | 31 | 32 | 47 | 16 | 55 | 8 | 59 | 4 | 1 | 62 | 13 | 50 | 27 | 36 | 45 | 18 | 5 | 58 | 37 | 26 |

In the example of the above table, the bits b of the output pseudorandom bit streams 30 are selected from initial bit stream indices m that follow a deterministic pattern. This pattern alternates between sequentially increasing and sequentially decreasing columns of the Latin rectangle, where the different columns have different offsets.

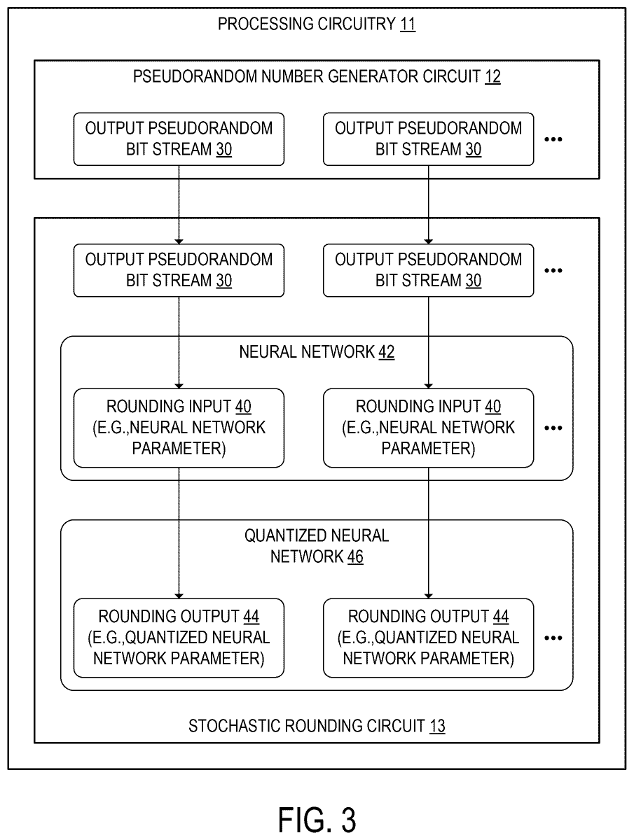

The PRNG circuit 12 is further configured to output the plurality of output pseudorandom bit streams 30. As shown in the example of FIG. 1, the PRNG circuit 12 may be coupled to a stochastic rounding circuit 13 that is configured to receive the output pseudorandom bit streams 30. FIG. 3 schematically shows the stochastic rounding circuit 13 when the output pseudorandom bit streams 30 are received. Based at least in part on the plurality of output pseudorandom bit streams 30, the stochastic rounding circuit 13 is configured to perform stochastic rounding on a plurality of rounding inputs 40 to compute a respective plurality of rounding outputs 44. The stochastic rounding circuit 13 is further configured to output the rounding outputs 44. For example, the rounding inputs 40 may be neural network parameters included in a neural network 42. The rounding outputs 44 may accordingly be quantized neural network parameters included in a quantized neural network 46.

FIG. 2B schematically shows the PRNG circuit 12 in an example in which the initial pseudorandom bit stream 22 is generated using an alternative approach. In the example of FIG. 2B, rather than using a Trivium algorithm 20, the PRNG circuit 12 is configured to compute the initial pseudorandom bit stream 22 using one or more linear feedback shift registers (LFSRs) 26. An LFSR 26 is a shift register with an input bit computed as a linear function of its previous state. The one or more LFSRs 26 included in the PRNG circuit 12 may be instantiated as hardware-level circuits.

FIG. 2C schematically shows the PRNG circuit 12 in an example in which some repeats are allowed among the initial stream bit indices m at a given output stream bit index n. In the example of FIG. 2C, for each of the output pseudorandom bit streams 30, for each output stream bit index n within that output pseudorandom bit stream 30, the corresponding initial stream bit index m is included 2^{N-n} or fewer times across the plurality of output pseudorandom bit streams 30. Thus, as each output pseudorandom bit stream 30 progresses from the most significant bit (at the beginning of the output pseudorandom bit stream 30) toward the least significant bit (at the end of the output pseudorandom bit stream 30), the number of allowed repeats increases.

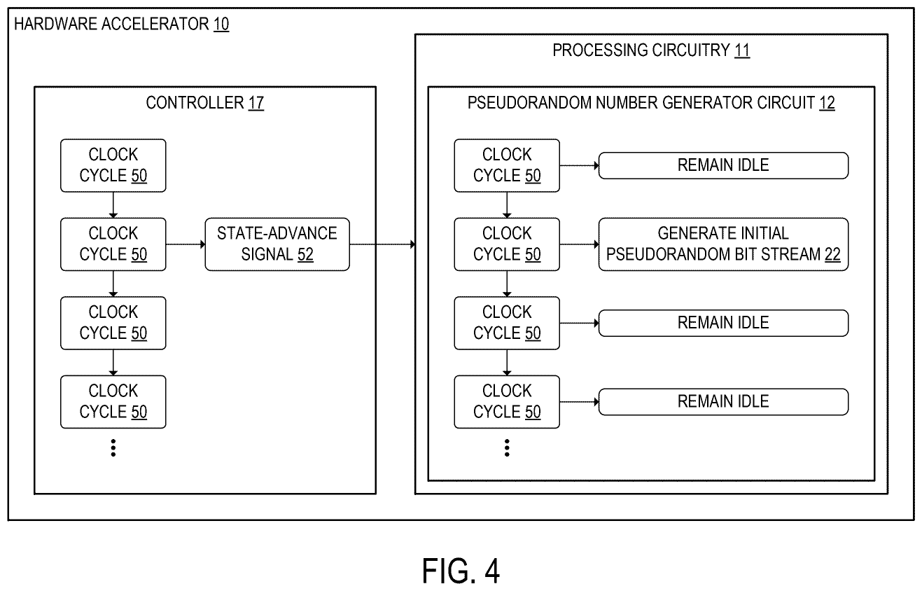

FIG. 4 schematically shows the PRNG circuit 12 and the controller 17 included in the hardware accelerator 10 as the hardware accelerator 10 progresses through a plurality of clock cycles 50. In the example of FIG. 4, the PRNG circuit 12 is configured to receive a state-advance signal 52 from the controller 17 at a clock cycle 50 included among the plurality of clock cycles 50. However, at the other clock cycles 50 shown in FIG. 4, the controller 17 does not transmit a state-advance signal 52 to the PRNG circuit 12.

The PRNG circuit 12 is further configured to compute the initial pseudorandom bit stream 22 and the plurality of output pseudorandom bit streams 30 in response to receiving the state-advance signal 52. In contrast, the PRNG circuit 12 is configured to remain idle during each clock cycle 50 in which the state-advance signal 52 is not received. By selectively performing pseudorandom number generation at clock cycles 50 at which it receives the state-advance signal 52, the PRNG circuit 12 is configured to generate the output pseudorandom bit streams 30 in a manner that can be deterministically reconstructed, as discussed in further detail below.

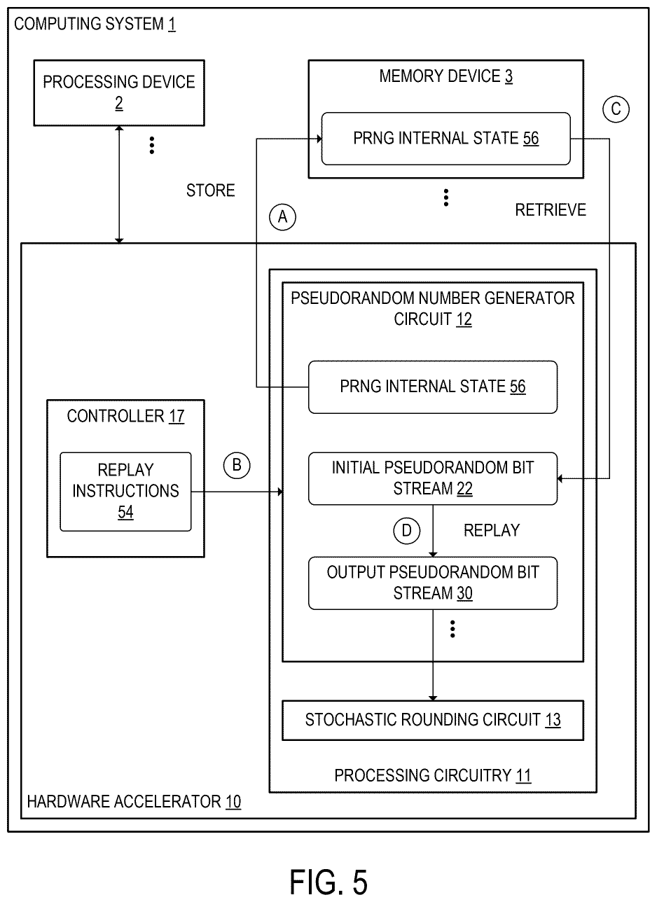

FIG. 5 schematically shows the computing system 1 when the PRNG circuit 12 replays the computation of the output pseudorandom bit streams 30. At step A of the replay, the PRNG circuit 12 is configured to store a PRNG internal state 56 in the one or more memory devices 3. In other examples, the PRNG internal state 56 may be stored in memory within the hardware accelerator 10. At step B, the PRNG circuit 12 is further configured to receive replay instructions 54 from the controller 17. The replay instructions are received subsequently to computing the output pseudorandom bit streams 30. At step C, in response to receiving the replay instructions 54, the PRNG circuit 12 is further configured to retrieve the PRNG internal state 56 from the one or more memory devices 3.

At step D, the PRNG circuit 12 is further configured to deterministically replay the computation of the output pseudorandom bit streams 30 using the PRNG internal state 56. To deterministically replay this computation, the PRNG circuit 12 is configured to generate the output pseudorandom bit streams 30 by regenerating the initial pseudorandom bit stream 22 as specified by the PRNG internal state 56. The PRNG circuit 12 is further configured to regenerate the output pseudorandom bit streams 30 using the same initial stream bit index orderings 24 that were initially used to compute the output pseudorandom bit streams 30. The PRNG circuit 12 is further configured to output the output pseudorandom bit streams 30 computed during the deterministic replaying.

The computation of the output pseudorandom bit streams 30 may, for example, be reconstructed in order to restore a previous device state during debugging or when recovering from a system failure. Exact clock cycle replay may be impractical to perform at the PRNG circuit 12. Thus, by selectively computing the output pseudorandom bit streams 30 in response to receiving the state-advance signal 52, the PRNG circuit 12 may enable reconstruction of its state at a corresponding prior clock cycle 50.

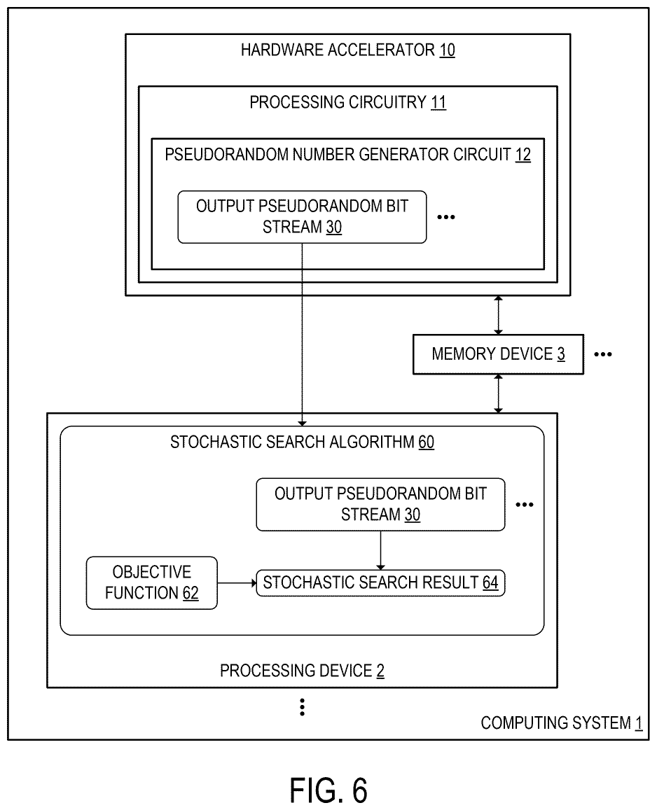

Although, in the above examples, the output pseudorandom bit streams 30 are used during neural network quantization, output pseudorandom bit streams 30 may be used in other applications that receive pseudorandom numbers as input. FIG. 6 schematically shows the computing system 1 in an example in which the one or more processing devices 2 are configured to execute a stochastic search algorithm 60. For example, the stochastic search algorithm 60 may be a simulated annealing algorithm, a simulated quantum annealing algorithm, a parallel tempering algorithm, a diffusion Monte Carlo algorithm, a population annealing algorithm, a sub-stochastic Monte Carlo algorithm, or some other stochastic search algorithm.

In the example of FIG. 6, the one or more processing devices 2 are configured to receive the plurality of output pseudorandom bit streams 30 from the hardware accelerator 10. The one or more processing devices 2 are further configured to execute the stochastic search algorithm 60 based at least in part on the output pseudorandom bit streams 30 to obtain a stochastic search result 64. In addition to the output pseudorandom bit streams 30, the stochastic search algorithm 60 further receives an objective function 62 as input. The objective function 62 is a function for which the stochastic search algorithm 60 is configured to approximate a minimum or maximum. The objective function 62 may be a function of a plurality of variables that are stochastically updated over a plurality of solver iterations using the output pseudorandom bit streams 30. Thus, the one or more processing devices 2 are configured to compute the stochastic search result 64 over the plurality of solver iterations. The one or more processing devices 2 are further configured to output the stochastic search result 64.

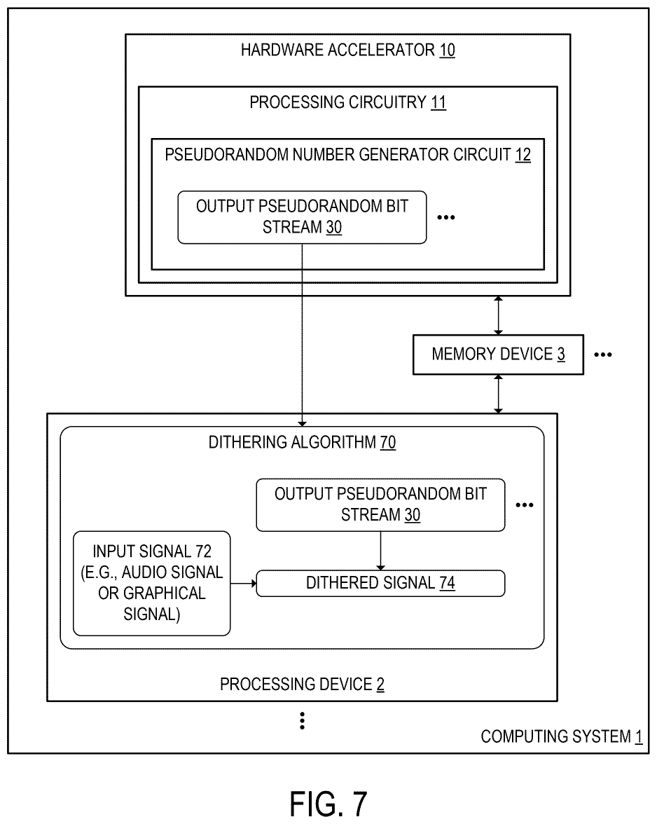

FIG. 7 schematically shows the computing system 1 in an example in which the one or more processing devices 2 are configured to perform dithering using the output pseudorandom bit streams 30. In the example of FIG. 7, the one or more processing devices 2 are configured to receive the plurality of output pseudorandom bit streams 30 from the hardware accelerator 10. The one or more processing devices 2 are further configured to execute a dithering algorithm 70 apply dithering to an input signal 72 based at least in part on the output pseudorandom bit streams 30. For example, the input signal 72 may be image data, audio data, or some other type of signal. Thus, the one or more processing devices 2 are configured to obtain a dithered signal 74. The one or more processing devices 2 are further configured to output the dithered signal 72. Accordingly, the output pseudorandom bit streams 30 are used to reduce quantization error in the input signal 72. Reducing the quantization error may avoid effects such as color banding in images or distortion artifacts in low-amplitude audio data.

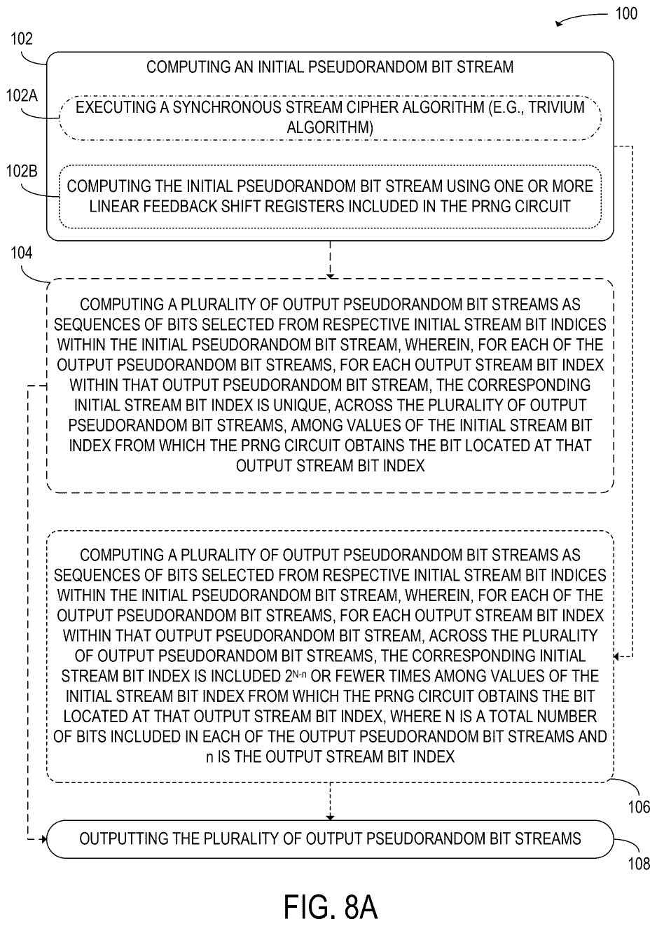

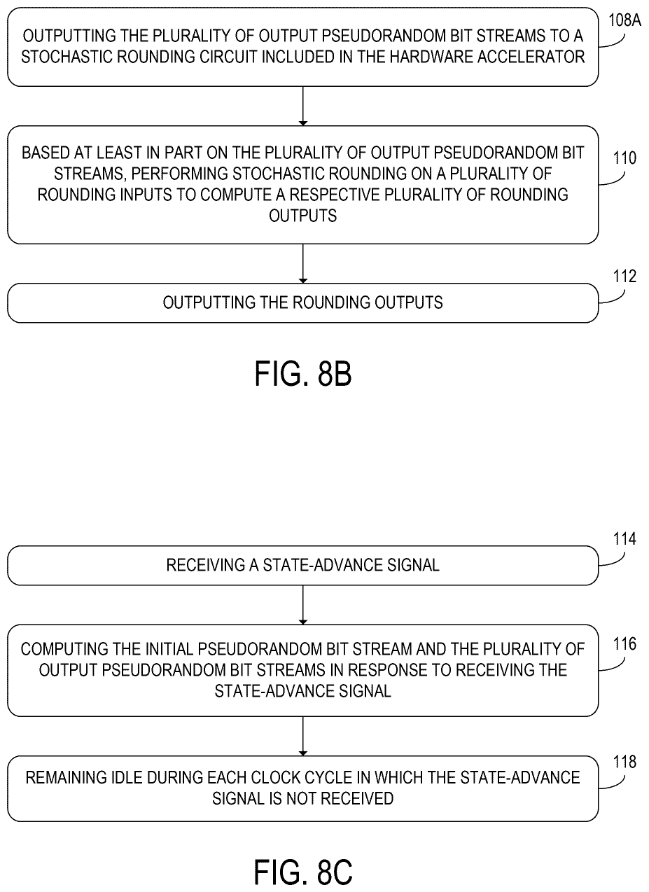

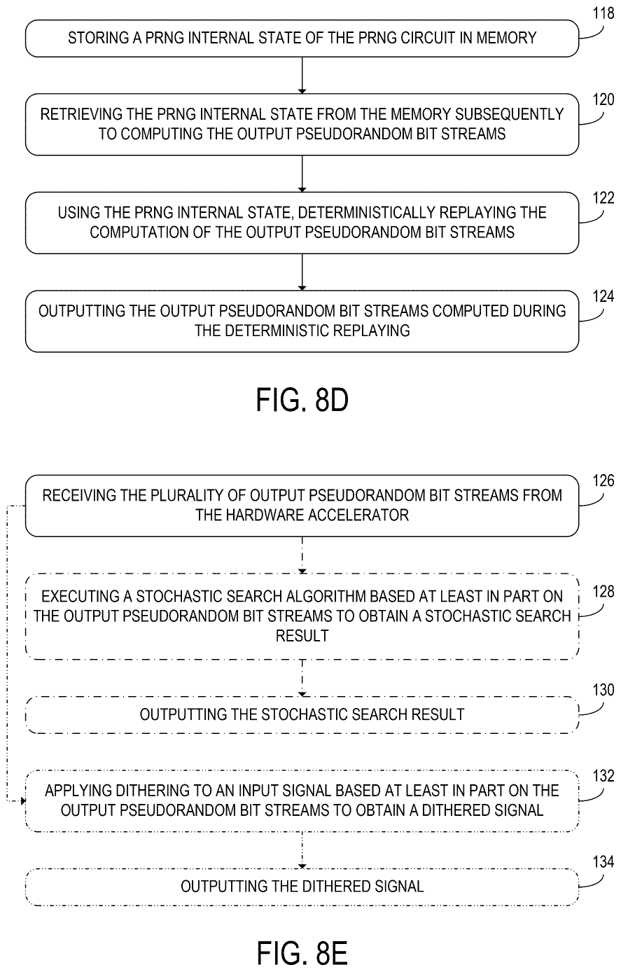

FIG. 8A shows a flowchart of a method 100 for use with a computing system including a hardware accelerator. The steps shown in FIG. 8A are performed at a PRNG circuit included in the hardware accelerator. At step 102, the method 100 includes computing an initial pseudorandom bit stream. The initial pseudorandom bit stream is a pseudorandom sequence including a predetermined number of bits that have respective initial stream bit indices. The initial stream bit indices specify the locations of the bits within the initial pseudorandom bit stream.

In some examples, at step 102A, step 102 may include executing a synchronous stream cipher algorithm such as a Trivium algorithm to compute the initial pseudorandom bit stream. Other pseudorandom bit generation algorithms or circuits may be used in other examples. For example, at step 102B, step 102 may include computing the initial pseudorandom bit stream using one or more LFSRs included in the PRNG circuit.

At step 104, the method 100 further includes computing a plurality of output pseudorandom bit streams as sequences of bits selected from respective initial stream bit indices within the initial pseudorandom bit stream. The output pseudorandom bit streams are sequences of bits that have respective output stream bit indices specifying the locations of those bits with the output pseudorandom bit stream. Each output pseudorandom bit stream is computed by arranging a plurality of the bits of the initial pseudorandom bit stream according to an input stream bit index ordering. For each of the output pseudorandom bit streams, for each output stream bit index within that output pseudorandom bit stream, the value of the initial stream bit index from which the PRNG circuit obtains the bit located at that output stream bit index satisfies a uniqueness property. According to this uniqueness property, the corresponding initial stream bit index associated with that output stream bit index is unique across the plurality of output pseudorandom bit streams. Therefore, the initial stream bit index orderings of the output pseudorandom bit streams are arranged as rows of an array, that array is a Latin rectangle.

In some examples, repeats of initial stream bit indices may be allowed at some positions within the output pseudorandom bit streams. In such examples, the method 100 may include executing step 106 instead of step 104. At step 106, the method 100 further includes computing a plurality of output pseudorandom bit streams as sequences of bits selected from respective initial stream bit indices within the initial pseudorandom bit stream. For each of the output pseudorandom bit streams, for each output stream bit index within that output pseudorandom bit stream, across the plurality of output pseudorandom bit streams, the corresponding initial stream bit index is included 2^{N-n} or fewer times, where n is the output stream bit index, among values of the initial stream bit index from which the PRNG circuit obtains the bit located at that output stream bit index. In the above expression, N is the total number of bits included in each of the output pseudorandom bit streams. The number of allowed repeats accordingly increases as the output pseudorandom bit stream progresses from the most significant bit toward the least significant bit.

At step 104 or 106, the plurality of output pseudorandom bit streams may be computed in parallel at the PRNG circuit. Thus, the plurality of output pseudorandom bit streams may be computed in a time-efficient manner.

At step 108, subsequently to computing the output pseudorandom bit streams, the method 100 further includes outputting the plurality of output pseudorandom bit streams.

FIG. 8B shows additional steps of the method 100 that may be performed in examples in which the output pseudorandom bit streams are used in stochastic rounding. At step 108A, step 108 may include outputting the plurality of output pseudorandom bit streams to a stochastic rounding circuit included in the hardware accelerator. Steps 110 and 112 may be performed at the stochastic rounding circuit. At step 110, based at least in part on the plurality of output pseudorandom bit streams, the method 100 may further include performing stochastic rounding on a plurality of rounding inputs to compute a respective plurality of rounding outputs. At step 112, the method 100 may further include outputting the rounding outputs. In some examples, the rounding inputs are neural network parameters included in a neural network, and the rounding outputs are quantized neural network parameters.

FIG. 8C shows additional steps of the method 100 that may be performed at the PRNG circuit in some examples. At step 114, the method 100 may further include receiving a state-advance signal. The state-advance signal may be received from a controller included in the hardware accelerator. At step 116, the method 100 may further include computing the initial pseudorandom bit stream and the plurality of output pseudorandom bit streams in response to receiving the state-advance signal. At step 118, the method 100 may further include remaining idle during each clock cycle in which the state-advance signal is not received. Selectively generating the output pseudorandom bit streams rather than performing pseudorandom number generation at every clock cycle may increase the replayability of pseudorandom output bit stream computation during debugging and failure recovery.

FIG. 8D shows additional steps of the method 100 that may be performed at the PRNG circuit in some examples to replay output pseudorandom bit stream computation. At step 118, the method 100 may further include storing a PRNG internal state of the PRNG circuit in memory. The memory at which the PRNG internal state is stored may be located within the hardware accelerator or on a separate memory device. At step 120, the method 100 may further include retrieving the PRNG internal state from the memory subsequently to computing the output pseudorandom bit streams. The PRNG internal state may accordingly be retrieved at a clock cycle that occurs later than the one or more clock cycles at which the output pseudorandom bit streams are computed.

At step 122, the method 100 may further include deterministically replaying the computation of the output pseudorandom bit streams using the PRNG internal state. At step 124, the method 100 may further include outputting the output pseudorandom bit streams computed during the deterministic replaying. The PRNG circuit may accordingly reproduce its earlier computations during debugging or failure recovery.

FIG. 8E shows steps of the method 100 that may be performed at one or more additional processing devices in some examples when the output pseudorandom bit streams are used as inputs to computations other than stochastic rounding. At step 126, the method 100 may further include receiving the plurality of output pseudorandom bit streams from the hardware accelerator.

In some examples, subsequently to step 126, the method 100 may further include performing steps 128 and 130. At step 128, the method 100 may further include executing a stochastic search algorithm based at least in part on the output pseudorandom bit streams to obtain a stochastic search result. An objective function may also be used as an input to the stochastic search function. At step 130, the method 100 may further include outputting the stochastic search result.

In other examples, steps 132 and 134 may be performed subsequently to step 126. At step 132, the method 100 may further include applying dithering to an input signal based at least in part on the output pseudorandom bit streams to obtain a dithered signal. For example, the input signal may include audio data or image data. At step 134, the method 100 may further include outputting the dithered signal.

Using the devices and methods discussed above, pseudorandom bit streams may be generated in an efficient manner. Compared to using a separate instance of Trivium to generate each output pseudorandom bit stream, the devices and methods discussed above offer a speedup by a number of times approximately equal to the number of output pseudorandom bit streams generated from each initial pseudorandom bit stream. The above devices and methods may also reduce chip area and energy consumption associated with pseudorandom number generation. The devices and methods discussed above may therefore significantly increase the speed of processes such as stochastic rounding, stochastic search, and dithering that utilize large numbers of pseudorandom numbers. This speedup is particularly relevant in machine learning settings, in which stochastic rounding is frequently used to quantize neural network weights. Stochastic search algorithms are also used in some machine learning systems, such as those that utilize neural networks with Monte Carlo tree search. Accordingly, the devices and methods discussed above may result in efficiency increases at multiple components of a machine learning system.

The methods and processes described herein are tied to a computing system of one or more computing devices. In particular, such methods and processes can be implemented as a computer-application program or service, an application-programming interface (API), a library, and/or other computer-program product.

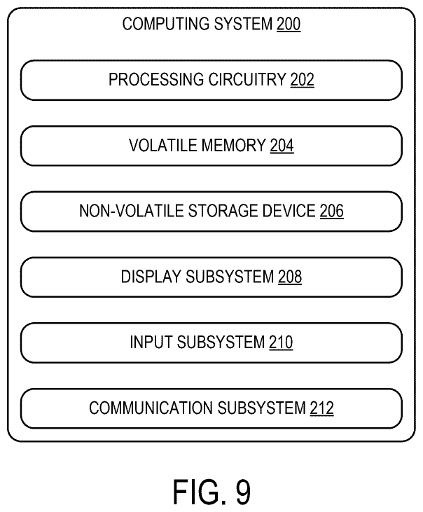

FIG. 9 schematically shows a non-limiting embodiment of a computing system 200 that can enact one or more of the methods and processes described above. Computing system 200 is shown in simplified form. Computing system 200 may embody the computing system 1 described above and illustrated in FIG. 1. Components of computing system 200 may be included in one or more personal computers, server computers, tablet computers, home-entertainment computers, network computing devices, video game devices, mobile computing devices, mobile communication devices (e.g., smartphone), and/or other computing devices, and wearable computing devices such as smart wristwatches and head mounted augmented reality devices.

Computing system 200 includes processing circuitry 202, volatile memory 204, and a non-volatile storage device 206. Computing system 200 may optionally include a display subsystem 208, input subsystem 210, communication subsystem 212, and/or other components not shown in FIG. 9.

Processing circuitry 202 typically includes one or more logic processors, which are physical devices configured to execute instructions. For example, the logic processors may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors configured to execute software instructions. Additionally or alternatively, the logic processor may include one or more hardware logic circuits or firmware devices configured to execute hardware-implemented logic or firmware instructions. Processors of the processing circuitry 202 may be single-core or multi-core, and the instructions executed thereon may be configured for sequential, parallel, and/or distributed processing. Individual components of the processing circuitry 202 optionally may be distributed among two or more separate devices, which may be remotely located and/or configured for coordinated processing. For example, aspects of the computing system 200 disclosed herein may be virtualized and executed by remotely accessible, networked computing devices configured in a cloud-computing configuration. In such a case, these virtualized aspects are run on different physical logic processors of various different machines. These different physical logic processors of the different machines will be understood to be collectively encompassed by processing circuitry 202.

Non-volatile storage device 206 includes one or more physical devices configured to hold instructions executable by the processing circuitry to implement the methods and processes described herein. When such methods and processes are implemented, the state of non-volatile storage device 206 may be transformed—e.g., to hold different data.

Non-volatile storage device 206 may include physical devices that are removable and/or built in. Non-volatile storage device 206 may include optical memory, semiconductor memory, and/or magnetic memory, or other mass storage device technology. Non-volatile storage device 206 may include nonvolatile, dynamic, static, read/write, read-only, sequential-access, location-addressable, file-addressable, and/or content-addressable devices. It will be appreciated that non-volatile storage device 206 is configured to hold instructions even when power is cut to the non-volatile storage device 206.

Volatile memory 204 may include physical devices that include random access memory. Volatile memory 204 is typically utilized by processing circuitry 202 to temporarily store information during processing of software instructions. It will be appreciated that volatile memory 204 typically does not continue to store instructions when power is cut to the volatile memory 204.

Aspects of processing circuitry 202, volatile memory 204, and non-volatile storage device 206 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 200 typically implemented in software by a processor to perform a particular function using portions of volatile memory, which function involves transformative processing that specially configures the processor to perform the function. Thus, a module, program, or engine may be instantiated via processing circuitry 202 executing instructions held by non-volatile storage device 206, using portions of volatile memory 204. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 208 may be used to present a visual representation of data held by non-volatile storage device 206. The visual representation may take the form of a graphical user interface (GUI). As the herein described methods and processes change the data held by the non-volatile storage device 206, and thus transform the state of the non-volatile storage device 206, the state of display subsystem 208 may likewise be transformed to visually represent changes in the underlying data. Display subsystem 208 may include one or more display devices utilizing virtually any type of technology. Such display devices may be combined with processing circuitry 202, volatile memory 204, and/or non-volatile storage device 206 in a shared enclosure, or such display devices may be peripheral display devices.

When included, input subsystem 210 may comprise or interface with one or more user-input devices such as a keyboard, mouse, touch screen, camera, or microphone.

When included, communication subsystem 212 may be configured to communicatively couple various computing devices described herein with each other, and with other devices. Communication subsystem 212 may include wired and/or wireless communication devices compatible with one or more different communication protocols. As non-limiting examples, the communication subsystem 212 may be configured for communication via a wired or wireless local- or wide-area network, broadband cellular network, etc. In some embodiments, the communication subsystem 212 may allow computing system 200 to send and/or receive messages to and/or from other devices via a network such as the Internet.

The following paragraphs discuss several aspects of the present disclosure. According to one aspect of the present disclosure, a computing system is provided, including a hardware accelerator that includes a pseudorandom number generator (PRNG) circuit configured to compute an initial pseudorandom bit stream. The PRNG circuit is further configured to compute a plurality of output pseudorandom bit streams as sequences of bits selected from respective initial stream bit indices within the initial pseudorandom bit stream. For each of the output pseudorandom bit streams, for each output stream bit index within that output pseudorandom bit stream, the corresponding initial stream bit index is unique, across the plurality of output pseudorandom bit streams, among values of the initial stream bit index from which the PRNG circuit obtains the bit located at that output stream bit index. The PRNG circuit is further configured to output the plurality of output pseudorandom bit streams. The above features may have the technical effect of computing a plurality of output pseudorandom bit streams in a time-efficient manner.

According to this aspect, the PRNG circuit may be configured to compute the initial pseudorandom bit stream by executing a Trivium algorithm. The above feature may have the technical effect of generating the initial pseudorandom bit stream.

According to this aspect, the PRNG circuit may be configured to compute the initial pseudorandom bit stream using one or more linear feedback shift registers (LFSRs). The above feature may have the technical effect of generating the initial pseudorandom bit stream.

According to this aspect, the PRNG circuit may be configured to output the plurality of output pseudorandom bit streams to a stochastic rounding circuit included in the hardware accelerator. The stochastic rounding circuit may be configured to, based at least in part on the plurality of output pseudorandom bit streams, perform stochastic rounding on a plurality of rounding inputs to compute a respective plurality of rounding outputs. The stochastic rounding circuit may be further configured to output the rounding outputs. The above features may have the technical effect of performing stochastic rounding using the output pseudorandom bit streams.

According to this aspect, the rounding inputs may be neural network parameters included in a neural network. The rounding outputs may be quantized neural network parameters. The above features may have the technical effect of efficiently quantizing the neural network parameters.

According to this aspect, the PRNG circuit may be further configured to receive a state-advance signal. The PRNG circuit may be further configured to compute the initial pseudorandom bit stream and the plurality of output pseudorandom bit streams in response to receiving the state-advance signal. The PRNG circuit may be further configured to remain idle during each clock cycle in which the state-advance signal is not received. The above features may have the technical effect of reducing power consumption by the PRNG circuit during clock cycles in which output pseudorandom bit streams are not used.

According to this aspect, the PRNG circuit may be further configured to store a PRNG internal state of the PRNG circuit in memory. The PRNG circuit may be further configured to retrieve the PRNG internal state from the memory subsequently to computing the output pseudorandom bit streams. Using the PRNG internal state, the PRNG circuit may be further configured to deterministically replay the computation of the output pseudorandom bit streams. The PRNG circuit may be further configured to output the output pseudorandom bit streams computed during the deterministic replaying. The above features may have the technical effect of deterministically replaying the computation of the output pseudorandom bit streams for use in debugging or crash recovery.

According to this aspect, the PRNG circuit may be configured to compute the plurality of output pseudorandom bit streams in parallel. The above feature may have the technical effect of computing the output pseudorandom bit streams in a time-efficient manner.

According to this aspect, the computing system may further include one or more additional processing devices configured to receive the plurality of output pseudorandom bit streams from the hardware accelerator. The one or more additional processing devices may be further configured to execute a stochastic search algorithm based at least in part on the output pseudorandom bit streams to obtain a stochastic search result. The one or more additional processing devices may be further configured to output the stochastic search result. The above features may have the technical effect of using the PRNG circuit as a source of pseudorandom bits in a stochastic search algorithm.

According to this aspect, the computing system may further include one or more additional processing devices configured to receive the plurality of output pseudorandom bit streams from the hardware accelerator. The one or more additional processing devices may be further configured to apply dithering to an input signal based at least in part on the output pseudorandom bit streams to obtain a dithered signal. The one or more additional processing devices may be further configured to output the dithered signal. The above features may have the technical effect of using the PRNG circuit as a source of pseudorandom bits in signal dithering.

According to another aspect of the present disclosure, a method for use with a computing system including a hardware accelerator is provided. The method includes, at a pseudorandom number generator (PRNG) circuit included in the hardware accelerator, computing an initial pseudorandom bit stream. The method further includes, at the PRNG circuit, computing a plurality of output pseudorandom bit streams as sequences of bits selected from respective initial stream bit indices within the initial pseudorandom bit stream. For each of the output pseudorandom bit streams, for each output stream bit index within that output pseudorandom bit stream, the corresponding initial stream bit index is unique, across the plurality of output pseudorandom bit streams, among values of the initial stream bit index from which the PRNG circuit obtains the bit located at that output stream bit index. The method further includes outputting the plurality of output pseudorandom bit streams. The above features may have the technical effect of computing a plurality of output pseudorandom bit streams in a time-efficient manner.

According to this aspect, the initial pseudorandom bit stream may be computed by executing a Trivium algorithm. The above feature may have the technical effect of generating the initial pseudorandom bit stream.

According to this aspect, the initial pseudorandom bit stream may be computed using one or more linear feedback shift registers (LFSRs) included in the PRNG circuit. The above feature may have the technical effect of generating the initial pseudorandom bit stream.

According to this aspect, the plurality of output pseudorandom bit streams may be output to a stochastic rounding circuit included in the hardware accelerator. The method may further include, at the stochastic rounding circuit, performing stochastic rounding on a plurality of rounding inputs to compute a respective plurality of rounding outputs based at least in part on the plurality of output pseudorandom bit streams. The method may further include outputting the rounding outputs. The above features may have the technical effect of performing stochastic rounding using the output pseudorandom bit streams.

According to this aspect, the rounding inputs may be neural network parameters included in a neural network. The rounding outputs may be quantized neural network parameters. The above features may have the technical effect of efficiently quantizing the neural network parameters.

According to this aspect, the method may further include receiving a state-advance signal at the PRNG circuit. The method may further include, at the PRNG circuit, computing the initial pseudorandom bit stream and the plurality of output pseudorandom bit streams in response to receiving the state-advance signal. The method may further include, at the PRNG circuit, remaining idle during each clock cycle in which the state-advance signal is not received. The above features may have the technical effect of reducing power consumption by the PRNG circuit during clock cycles in which output pseudorandom bit streams are not used.

According to this aspect, the method may further include, at the PRNG circuit, storing a PRNG internal state of the PRNG circuit in memory. The method may further include retrieving the PRNG internal state from the memory subsequently to computing the output pseudorandom bit streams. The method may further include, using the PRNG internal state, deterministically replaying the computation of the output pseudorandom bit streams. The method may further include outputting the output pseudorandom bit streams computed during the deterministic replaying. The above features may have the technical effect of deterministically replaying the computation of the output pseudorandom bit streams for use in debugging or crash recovery.

According to this aspect, the plurality of output pseudorandom bit streams may be computed in parallel at the PRNG circuit. The above feature may have the technical effect of computing the output pseudorandom bit streams in a time-efficient manner.

According to this aspect, at one or more additional processing devices, the method may further include receiving the plurality of output pseudorandom bit streams from the hardware accelerator. At the one or more additional processing devices, the method may further include executing a stochastic search algorithm based at least in part on the output pseudorandom bit streams to obtain a stochastic search result. At the one or more additional processing devices, the method may further include outputting the stochastic search result. The above features may have the technical effect of using the PRNG circuit as a source of pseudorandom bits in a stochastic search algorithm.

According to another aspect of the present disclosure, a computing system is provided, including a hardware accelerator that includes a pseudorandom number generator (PRNG) circuit configured to compute an initial pseudorandom bit stream. The PRNG circuit is further configured to compute a plurality of output pseudorandom bit streams as sequences of bits selected from respective initial stream bit indices within the initial pseudorandom bit stream. For each of the output pseudorandom bit streams, for each output stream bit index within that output pseudorandom bit stream, across the plurality of output pseudorandom bit streams, the corresponding initial stream bit index is included 2^{N-n} or fewer times among values of the initial stream bit index from which the PRNG circuit obtains the bit located at that output stream bit index, where N is a total number of bits included in each of the output pseudorandom bit streams and n is the output stream bit index. The PRNG circuit is further configured to output the plurality of output pseudorandom bit streams. The above features may have the technical effect of computing a plurality of output pseudorandom bit streams in a time-efficient manner.

“And/or” as used herein is defined as the inclusive or V, as specified by the following truth table:

| A | B | A ∨ B |
|---|---|---|
| True | True | True |
| True | False | True |
| False | True | True |
| False | False | False |

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing system comprising:
a hardware accelerator that includes a pseudorandom number generator (PRNG) circuit configured to:
compute an initial pseudorandom bit stream;
compute a plurality of output pseudorandom bit streams as sequences of bits selected from respective initial stream bit indices within the initial pseudorandom bit stream, wherein,
for each of the output pseudorandom bit streams,
for each output stream bit index within that output pseudorandom bit stream,
the corresponding initial stream bit index is unique, across the plurality of output pseudorandom bit streams, among values of the initial stream bit index from which the PRNG circuit obtains the bit located at that output stream bit index; and
output the plurality of output pseudorandom bit streams.

2. The computing system of claim 1, wherein the PRNG circuit is configured to compute the initial pseudorandom bit stream by executing a Trivium algorithm.

3. The computing system of claim 1, wherein the PRNG circuit is configured to compute the initial pseudorandom bit stream using one or more linear feedback shift registers (LFSRs).

4. The computing system of claim 1, wherein:
the PRNG circuit is configured to output the plurality of output pseudorandom bit streams to a stochastic rounding circuit included in the hardware accelerator; and
the stochastic rounding circuit is configured to:
based at least in part on the plurality of output pseudorandom bit streams, perform stochastic rounding on a plurality of rounding inputs to compute a respective plurality of rounding outputs; and
output the rounding outputs.

5. The computing system of claim 4, wherein:
the rounding inputs are neural network parameters included in a neural network; and
the rounding outputs are quantized neural network parameters.

6. The computing system of claim 1, wherein the PRNG circuit is further configured to:
receive a state-advance signal;
compute the initial pseudorandom bit stream and the plurality of output pseudorandom bit streams in response to receiving the state-advance signal; and
remain idle during each clock cycle in which the state-advance signal is not received.

7. The computing system of claim 1, wherein the PRNG circuit is further configured to:
store a PRNG internal state of the PRNG circuit in memory;
retrieve the PRNG internal state from the memory subsequently to computing the output pseudorandom bit streams;
using the PRNG internal state, deterministically replay the computation of the output pseudorandom bit streams; and
output the output pseudorandom bit streams computed during the deterministic replaying.

8. The computing system of claim 1, wherein the PRNG circuit is configured to compute the plurality of output pseudorandom bit streams in parallel.

9. The computing system of claim 1, further comprising one or more additional processing devices configured to:
receive the plurality of output pseudorandom bit streams from the hardware accelerator;
execute a stochastic search algorithm based at least in part on the output pseudorandom bit streams to obtain a stochastic search result; and
output the stochastic search result.

10. The computing system of claim 1, further comprising one or more additional processing devices configured to:
receive the plurality of output pseudorandom bit streams from the hardware accelerator;
apply dithering to an input signal based at least in part on the output pseudorandom bit streams to obtain a dithered signal; and
output the dithered signal.

11. A method for use with a computing system including a hardware accelerator, the method comprising:
at a pseudorandom number generator (PRNG) circuit included in the hardware accelerator:
computing an initial pseudorandom bit stream;
computing a plurality of output pseudorandom bit streams as sequences of bits selected from respective initial stream bit indices within the initial pseudorandom bit stream, wherein,
for each of the output pseudorandom bit streams,
for each output stream bit index within that output pseudorandom bit stream,
the corresponding initial stream bit index is unique, across the plurality of output pseudorandom bit streams, among values of the initial stream bit index from which the PRNG circuit obtains the bit located at that output stream bit index; and
outputting the plurality of output pseudorandom bit streams.

12. The method of claim 11, wherein the initial pseudorandom bit stream is computed by executing a Trivium algorithm.

13. The method of claim 11, wherein the initial pseudorandom bit stream is computed using one or more linear feedback shift registers (LFSRs) included in the PRNG circuit.

14. The method of claim 11, wherein:
the plurality of output pseudorandom bit streams are output to a stochastic rounding circuit included in the hardware accelerator; and
the method further comprises, at the stochastic rounding circuit:
based at least in part on the plurality of output pseudorandom bit streams, performing stochastic rounding on a plurality of rounding inputs to compute a respective plurality of rounding outputs; and
outputting the rounding outputs.

15. The method of claim 14, wherein:
the rounding inputs are neural network parameters included in a neural network; and
the rounding outputs are quantized neural network parameters.

16. The method of claim 11, further comprising, at the PRNG circuit:
receiving a state-advance signal;
computing the initial pseudorandom bit stream and the plurality of output pseudorandom bit streams in response to receiving the state-advance signal; and
remaining idle during each clock cycle in which the state-advance signal is not received.

17. The method of claim 11, further comprising, at the PRNG circuit:
storing a PRNG internal state of the PRNG circuit in memory;
retrieving the PRNG internal state from the memory subsequently to computing the output pseudorandom bit streams;
using the PRNG internal state, deterministically replaying the computation of the output pseudorandom bit streams; and
outputting the output pseudorandom bit streams computed during the deterministic replaying.

18. The method of claim 11, wherein the plurality of output pseudorandom bit streams are computed in parallel at the PRNG circuit.

19. The method of claim 11, further comprising, at one or more additional processing devices:
receiving the plurality of output pseudorandom bit streams from the hardware accelerator;
executing a stochastic search algorithm based at least in part on the output pseudorandom bit streams to obtain a stochastic search result; and
outputting the stochastic search result.

20. A computing system comprising:
a hardware accelerator that includes a pseudorandom number generator (PRNG) circuit configured to:
compute an initial pseudorandom bit stream;
compute a plurality of output pseudorandom bit streams as sequences of bits selected from respective initial stream bit indices within the initial pseudorandom bit stream, wherein,
for each of the output pseudorandom bit streams,
for each output stream bit index within that output pseudorandom bit stream,
across the plurality of output pseudorandom bit streams, the corresponding initial stream bit index is included 2^{N-n} or fewer times among values of the initial stream bit index from which the PRNG circuit obtains the bit located at that output stream bit index, where N is a total number of bits included in each of the output pseudorandom bit streams and n is the output stream bit index; and
output the plurality of output pseudorandom bit streams.
